(19) United States
(12) Patent Application Publication
(10) Pub. No.: US 2009/0145865 A1
(43) Pub. Date: Jun. 11, 2009

(54) Tool storage rack

(75) Inventor: Hsu Po Yu, Taichung (TW)

Correspondence Address: REED SMITH LLP, Suite 1400, 3110 Fair View Park Drive, Falls Church, VA, 22042, US

(73) Assignee: Lea Way Hand Tool Corporation

(21) Appl. No.: 12/081,202

(22) Filed: Apr. 11, 2008

(30) Foreign Application Priority Data
Dec. 7, 2007 (CN) 200710195935.X
Dec. 7, 2007 (CN) 200720310127.9

(51) Int. Cl. A47F 7/00; B25G 3/10; G06F 19/00

(52) U.S. Cl. 211/70.6; 403/20; 700/95; 211/60.1

(57) ABSTRACT

A tool storage rack is provided. The tool storage rack comprises a rack body for providing a hollow space, wherein the rack body includes at least one accommodation surface formed with an installation groove thereon. The present invention also provides at least one tool connector which can be partly inserted into the installation groove for engaging the rack body, so as to accommodate a tool. The at least one tool connector comprises: a first engaging end, which can be inserted into the installation groove of the rack body for installation on a backside of the accommodation surface; and a second engaging end, which can engage a tool to be accommodated.

### FIELD OF THE INVENTION

The present invention relates to a tool storage rack for storing hand tools, such as sockets.

### DESCRIPTION OF THE PRIOR ART

A tool storage rack (such as a socket rack) known in the art is generally configured with an exterior rail having a particular shape, such as T-shape, so as to allow a tool or tools to be accommodated in a desired position which is convenient to the users.

For example, U.S. Pat. No. 5,228,570 discloses a socket storage rack 20 with a quick release mechanism, which has a plurality of quick release mechanisms 22 to engage tools. The socket storage rack 20 has a groove on the surface thereof, said groove communicating with an interior hollow space. The wall surfaces on two sides of the hollow space are provided with dual-layered rails 68 which are symmetrical in structure to each other, wherein an upper rail of each dual-layered rail 68 is constructed to allow a middle large cylindrical body 24 of the quick release mechanism 22 to slide thereon, and a lower rail of each dual-layered rail 68 provides a space for accommodating shoulders 56, 58 which are connected to the large cylindrical body 24. A separate end cap 32 is provided at the end of the rail of the socket storage rack 20. Upon installation, the quick release mechanisms 22 slide into the hollow space via rails 68 along the longitudinal direction of the groove and then the end of the groove is capped with the end cap. However, such a socket storage rack 20 relies on an “interior rail” system including symmetrical rails 68 on the two inside walls of the inner space, which is complicated in structure. Accordingly, the socket storage rack 20 is not only costly to manufacture but also has high defective rate. The separate end cap also increases the manufacturing cost of socket storage rack 20.

Recently, there have been a number of patents about socket racks having “exterior rails.” The most significant difference between these patents and U.S. Pat. No. 5,228,570 lies in that socket racks with exterior rails are provided with rails outside the socket body to allow the socket connectors to be slidably installed on the rails. For example, TW 338418, U.S. Pat. No. 5,862,913, TW 388326, TW 478-450, U.S. Pat. No. 6,044,985, TW 507659, TW 405507, U.S. Pat. No. 6,415,933, TW 501526, and U.S. Pat. No. 6,669,032 all relate to socket racks in this respect. However, the “exterior rails” of socket racks known in the art inevitably increase manufacturing costs. There is a need to provide a socket rack without exterior rails so as to reduce the manufacturing cost.

### SUMMARY OF THE INVENTION

The present invention is directed to a tool storage rack, which has such advantages as simplified structure, easy manufacturing process, and low cost.

According to the present invention, a tool storage rack includes a rack body providing a hollow space, and the rack body further includes at least one accommodation surface having an installation groove thereon. The present invention also provides at least one tool connector which can be partly inserted into the installation groove to be engaged with the rack body, so as to accommodate a tool. The at least one tool connector includes: a first engaging end configured for passing through the installation groove of the rack body and installed on a backside of the accommodation surface; and a second engaging end for engaging a tool to be accommodated. The tool connector preferably includes a limit block for positioning the tool connector between the accommodation surface and the limit block, so as to prevent the tool connector from accidentally falling out of the installation groove. Compared with conventional socket holders, the tool storage rack of the present invention not only reduces the number of elements of a tool storage rack, but also enhances the strength and reduces the manufacturing cost.

The above and other detailed features and advantages of the present invention can be further understood by referring to the following descriptions and accompanying drawings.

### BRIEF DESCRIPTION OF THE DRAWINGS

FIGS. 1A-1C illustrate a first embodiment of the present invention in a first state;

FIGS. 2A-2C illustrate a first embodiment of the present invention in a second state in which the tool connector is positioned in place after being rotated by an angle, preferably 90 degrees;

FIGS. 3A to 3C illustrate a tool connector of the present invention;

FIGS. 4A to 4D illustrate a second embodiment of the present invention;

FIGS. 5A to 5G illustrate a third embodiment of the present invention;

FIGS. 6A to 6D illustrate a fourth embodiment of the present invention;

FIGS. 7A to 7G illustrate a fifth embodiment of the present invention;

FIGS. 8A to 8B illustrate a sixth embodiment of the present invention; and

FIGS. 9A to 9B illustrate a seventh embodiment of the present invention.

### DETAILED DESCRIPTION OF THE INVENTION AND PREFERRED EMBODIMENTS

### Embodiment 1

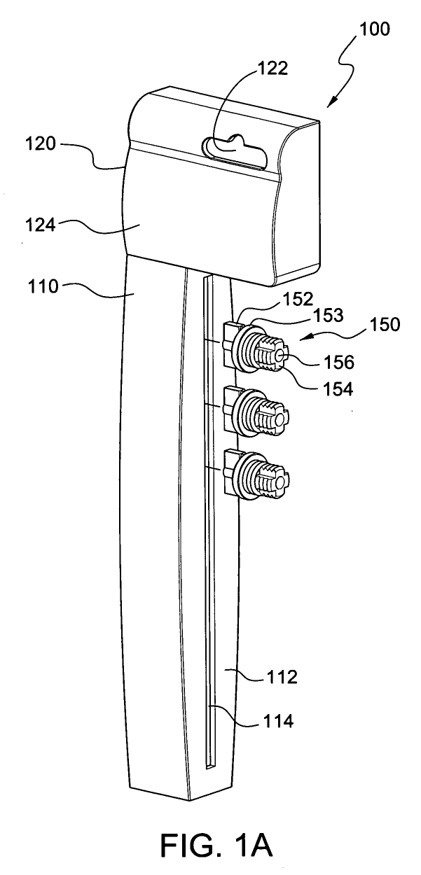

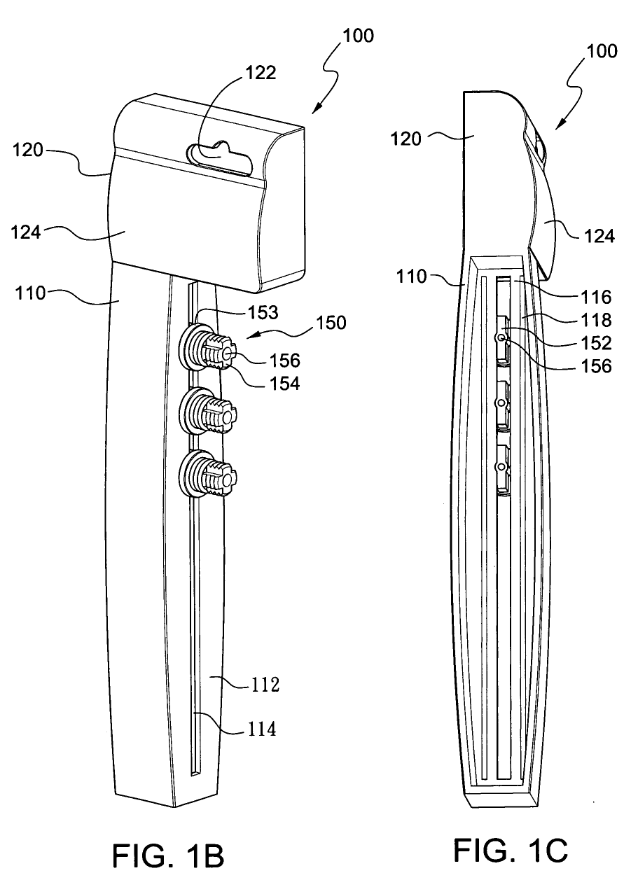

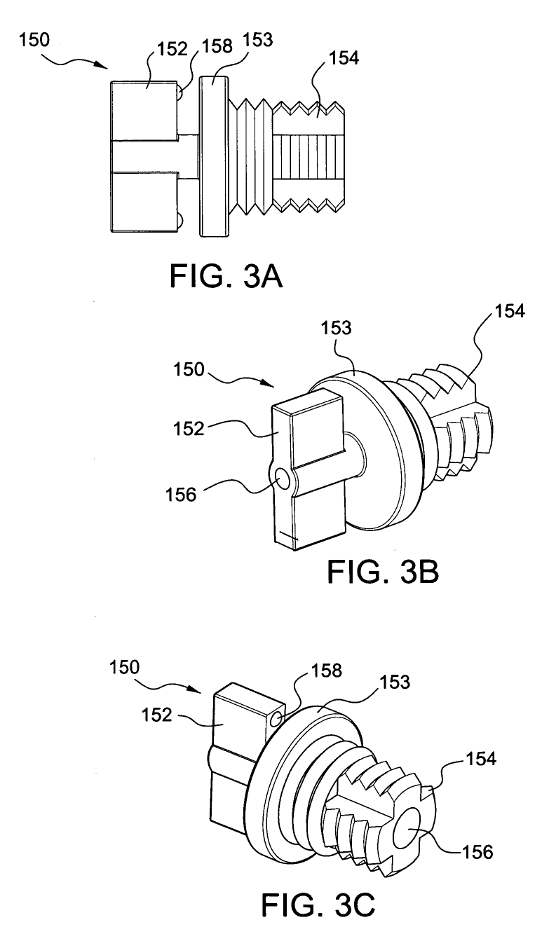

As shown in FIGS. 1A-1C, 2A-2C, and 3A-3C, according to a preferred embodiment of the present invention, a tool storage rack 100 of the present invention is a socket rack (the invention may also be used to accommodate other tools, such as a wrench), which substantially comprises: a rack body 110 providing a hollow space, which includes at least one accommodation surface 112 formed with an installation groove 114, and at least one tool connector 150 configured for partly insertion into the installation groove 114 along an installation direction to be engaged with the rack body 110.

According to the spirit of the present invention, in a basic embodiment, the nstallation groove 114 is preferably a closed, slit-shaped structure that does not extend to the end(s) of the rack body 110/accommodation surface 112, and a tool connector 150 may be installed at any position thereon. In this embodiment, the tool connector 150, after being inserted into the installation groove, is engaged with the rack body 110 preferably after being rotated by a certain angle (preferably 90 degrees), the installation direction of the tool connector 150 being different from the longitudinal direction/extending direction of the installation groove 114 (for example, the installation direction can be perpendicular to the longitudinal direction of the installation groove 114). In an alternative embodiment, the installation groove 114 does not extend to the ends of the rack body 110/the accommodation surface 112, and comprises an initiation portion at an appropriate position or positions configured for installation of the tool connector 150. The tool connector 150, after being inserted into the initiation portion along the installation direction perpendicular to the longitudinal direction of the installation groove 114, is slid to a desired or predetermined position. The initiation portion is then closed with a locking element, such as a sealing cover (not shown). The at least one tool connector 150 comprises: a first engaging end 152 configured for being inserted into the installation groove 114 of the rack body 110 along the installation direction and installed on a backside 116 of the accommodation surface 112; and a second engaging end 154 for connecting to a tool to be accommodated, such as a socket. The above embodiments may also have other similar variations; for example, the installation groove 114 may extend to the end(s) of the rack body 110 in a conventional manner and then be closed with an end cap (not shown) at the end, similar to U.S. Pat. No. 5,228,570 in which the installation groove extend to a free end of the rack body and the free end is closed with an end cap 32. Preferably, a limit block 153 on the tool connector 150 may be used as a barrier-like structure to work with the first engaging end 152 so that the tool connector 150, after being installed to the installation groove 114, can be confined by the accommodation surface 112 and the limit block 153. To work with the limit block 153, the first engaging end 152 may be shaped into a disk (not shown) or a block (not shown) which has a cross section that cannot pass through the installation groove 114. This can prevent the tool connector 150 from accidentally falling inside or out of the installation groove easily along a direction orthogonal to the longitudinal direction of the installation groove 114. The installation groove 114 may be formed as a single continuous slit or several discontinuous sections/slits. Furthermore, the rack body 110 and the installation groove 114 may alternatively be configured into various shapes, such as a round shape or a triangular shape, instead of the slit/strip shape shown in the figures.

The tool storage rack 100 may be further provided with a handle 120, a hanging part 122, and/or an information/advertisement window 124. The handle 120 may be a simple concave structure to be held by a user. For example, as shown in FIG. 1A, a concave groove is disposed beneath the hanging part 12 or at the back of the advertisement window 124, and can be held by a user. In the embodiments shown in the figures, the information/advertisement window 124 is disposed on the handle 120.

According to a preferred embodiment, the first engaging end 152 of the tool connector 150 is configured for installation on or disengagement from the installation groove 114 at a first angle and engagement with the installation groove 114 at a second angle different from the first angle. According to this concept, the first engaging end 152 of the tool connector 150 can be inserted into the installation groove 114 at a first angle, engaged with the backside 116 of the accommodation surface 112 after being rotated by a certain angle, and the disengaged from the backside 116 after being rotated by a certain angle (back to the first angle). In a preferred embodiment, the first engaging end 152 may be shaped into a tab or strip having a width less than that of the installation groove 114, so that it can pass through the installation groove in certain angle(s) for engagement with the backside 116 of the accommodation surface 112, and then disengage from the same after rotating certain angle(s) from the engaged state. The structure of the second engaging end 154 is configured according to the types of tools to be accommodated. For example, the tool connectors 150 shown in the figures are used to accommodate sockets. For tool storage rack 100 used to hold sockets, the outer surface of the second engaging end 154 can be provided with corrugations or wavy structure to work as a friction structure, so that a socket S can be held on the second engaging end 154 through the friction structure. According to a preferred embodiment, the second engaging end 154 includes a limit block 153 between the first engaging end 152 and the second engaging end 154 to work as a barrier, and the limit block 153 is preferably spaced apart from the first engaging end 152. The limit block 153 has a cross section larger than the width of the installation groove 114, so as to confine the tool connector 150 to be engaged between the accommodation surface 112 and the limit block 153. In one aspect, after the tool connector 150 is inserted into the installation groove 114 to couple with the rack body 110, the limit block 153 properly blocks (limits) the insertion motion or prevents the tool connector 150 from accidentally falling inside or out of the installation groove 112 easily. In another aspect, the limit block 153 can prevent the installed socket S from directly contacting the accommodation surface 112 to avoid undesired abrasions. The limit block 153 shown in the figure is round in shape, but it may also be of other shapes. According to an alternative embodiment, the second engaging end 154 may have a cross section larger than the width of the installation groove 114, so that the second engaging end 154 can take the place of a limit block 153 to limit the insertion motion of the first engaging end 152. A stabilization element (not shown) for contacting/engaging with the end of the first engaging end 152 may be optionally disposed in the hollow space of the rack body 110, so as to stabilize the first engaging end 152 after installation.

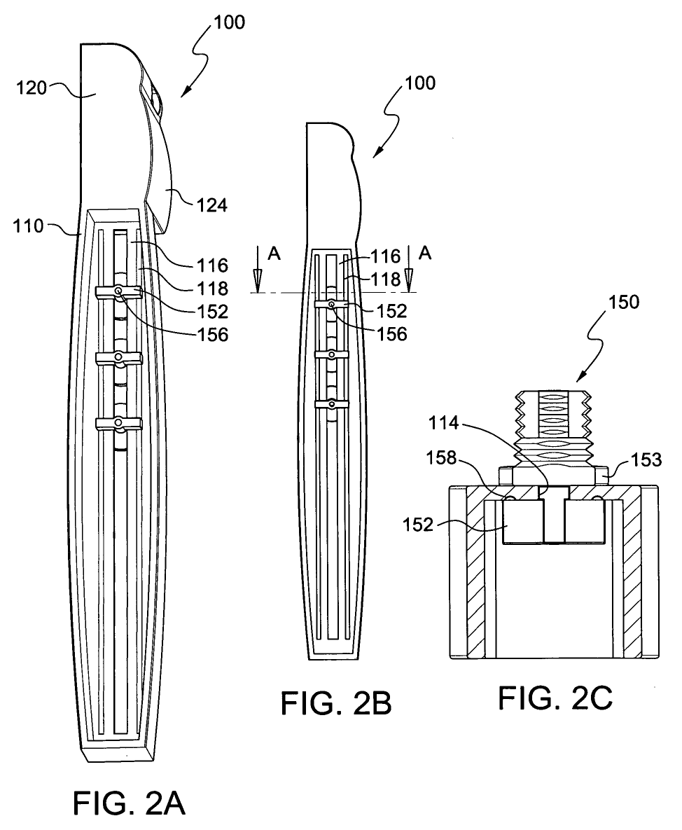

As shown in FIGS. 1A to 1C, to install the tool storage rack, the user first holds the second engaging end 154 and inserts the first engaging end 152 into the installation groove 114 along an installation direction (for example, an orthogonal direction) different from the longitudinal direction of the installation groove 114, until the insertion motion is blocked by, for example, the limit block 153, the second engaging end 154, or a stabilization element (not shown) located in the hollow space of the rack body 110. Thereafter, as shown in FIGS. 2A to 2C, the user rotates the first engaging end 152 by a certain angle (for example, about 90 degrees as shown in the figures) to secure the bottom surface of the first engaging end 152 in place by, for example, a backside 116 (the side facing the hollow space) of the accommodation surface 112 due to a stopping structure or friction forces thereon, or by other positioning elements, such as the stabilization element disposed in the hollow space of the rack body 110. According to a preferred embodiment, the backside 116 of the accommodation surface 112 is formed with a positioning structure 118, and, correspondingly, the first engaging end 152 of the tool connector 150 has a corresponding embedding part 158 on the bottom surface thereof for engaging the positioning structure 118. In such a manner, the tool connector 150, after being installed on the backside 116 of the accommodation surface 112, can stably slide to a desired position along the positioning structure 118. This “slidable” feature makes very convenient. Take a tool storage rack for storing sockets for example. When the sockets to be engaged with the tool connectors 150 have different diameters, such a slidable feature allows the sockets to abut each other when the installation of tool connectors 150 is complete (i.e., the tool connectors are moved to desired or predetermined installation positions). According to a preferred embodiment of the present invention, the positioning structure 118 on the backside 116 of the accommodation surface 112 is in the form of a single continuous trench-shaped positioning groove or several discontinuous positioning groove, and the embedding part 158 is a bump for engaging the positioning groove and slides therein. In another embodiment, the positioning structure 118 may also be in the form of positioning holes (not shown) at predetermined positions, so that the bump-shaped embedding part 158 can slide into the predetermined positioning hole for positioning.

According to the above descriptions, it can be known that the steps for assembling the tool storage rack are as follows.

1. Provide a rack body having a hollow space and at least one accommodation surface. The accommodation surface has a closed installation groove that does not extend to the end(s) of the rack body/the accommodation surface, and can be formed with a positioning structure on a backside thereof.

2. Provide at least one tool connector having a first engaging end and a second engaging end to connect to a tool to be accommodated.

3. Insert the first engaging end of the at least one tool connector into the installation groove (preferably into the installation groove along an installation direction different from the longitudinal direction of the installation groove), until the insertion action is blocked by a structure on the tool connector.

4. Rotate the tool connector by a certain angle, preferably 90 degrees, until the first engaging end is engaged on a backside of the accommodation surface for positioning.

It can be understood that, according to the above embodiments of the present invention, only the first engaging end 152 of the tool connector 150 is inserted into the installation groove 114 and then the tool connector 150 can be positioned (preferably after being rotated by a certain angle), e.g., in the positioning structure 118; meanwhile, the tool connector 150 can slide on the installation groove 114 for further positioning. Compared with the prior art using exterior rails (generally, T-shaped rails) coupling with slide blocks, which allows the tool connector to slide on the rails, the tool connector of the present invention has greatly improved efficacy. Particularly, the installation groove 114 on the rack body 110 of the present invention can be designed as a closed, slit-shaped structure that does not extend to the end(s) of the rack body 110/the accommodation surface 112, so that the rack body 110 does not need positioning blocks/end caps at the tail end (free end) thereof or solid external T-shaped rails which are usually needed in the prior art. The present invention therefore provides a couple of advantages over the prior art due to simpler structure of the rack body 110, lower manufacturing cost (particularly because the rack body 410 can be integrally formed), and greater strength.

### Embodiment 2

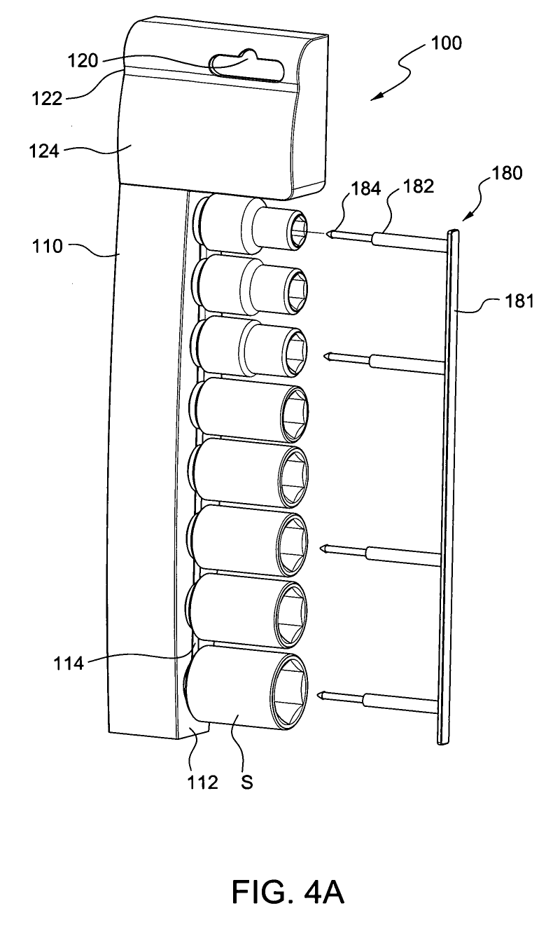

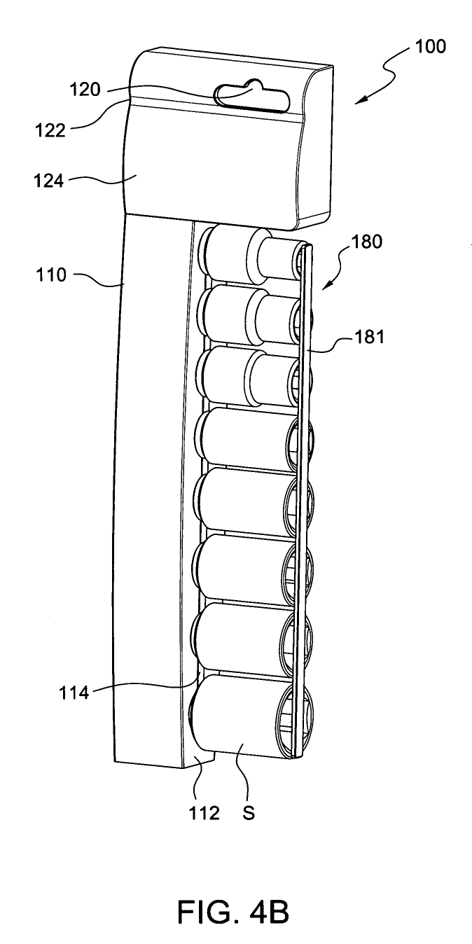

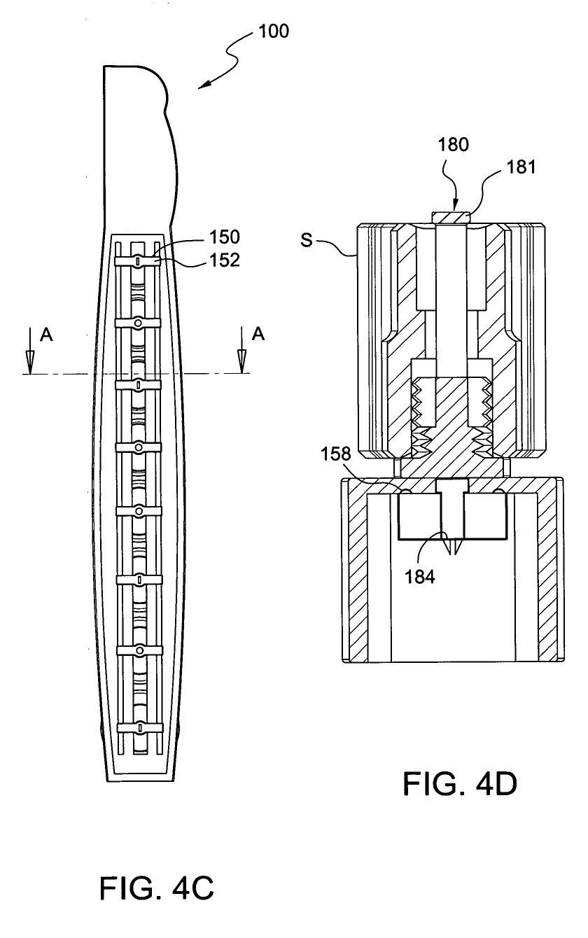

FIGS. 4A-4D are schematic views of the tool storage rack 100 to which an anti-theft assembly 180 is assembled, in which the tool connectors 150 are configured to secure sockets S.

The anti-theft assembly 180 has an elongated anti-theft member 181 working as a release-proof structure and at least one locking tab 182. The elongated anti-theft member 181 laterally extends through each locking tab 182. Each tool connector 150 is formed with a through hole 156 extending from the first engaging end 152 to the second engaging end 154 thereof corresponding to the locking tab 182. The through hole 156 preferably extends from the center of the first engaging end 152 to the center of the second engaging end 154. Accordingly, the locking tab 182 passes through the hollow portion of the socket S and extends from the second engaging end of the tool connector 150 to the first engaging end 152 through the through hole 156, and then engages the first engaging end 152. The locking tab 182 then is installed on the rack body 110 together with the tool connector 150 and the socket S. In this way, the elongated anti-theft assembly 180 with the release-proof structure can further secure the socket S, so as to prevent the socket S from accidentally falling off from the tool connector 150 and avoid unauthorized removal of the same from the tool connector 150.

According to a preferred embodiment, the end structure of each locking tab 182 is configured as a hollow structure of an arrow shape tapering from a thick stopper 184 to a thin end, which can be squeezed towards the hollow portion thereof, so that, after the thin end is squeezed and passed through the through hole 156, the stopper 184 expands outwards because the squeezing force is removed. Then the thin end cannot be retracted through the through hole 156. Corresponding to the end structure of the locking tab 182, the through hole 156 preferably has a tapering structure substantially tapering from the second engaging end 154 of the tool connector 150 towards the first engaging end 152. With this structure, the size of the stopper 184 can work with the smaller through hole 156 at the first engaging end 152. Therefore, the material can be reduced, and the desired stopping effect can be achieved.

According to this embodiment, the anti-theft assembly 180 prevents unauthorized removal of the sockets S from the tool connectors 150 of the tool storage rack 100. When the consumer wants to use the tool storage rack 100 after buying it, he/she merely needs to use a tool, such as scissors, to cut off the portion where the elongated anti-theft member 181 and the locking tab 182 are connected together. The cut-off portion of the locking tab 182 can be removed from the rack body 100 through an opening of the hollow space of the rack body 110.

### Embodiment 3

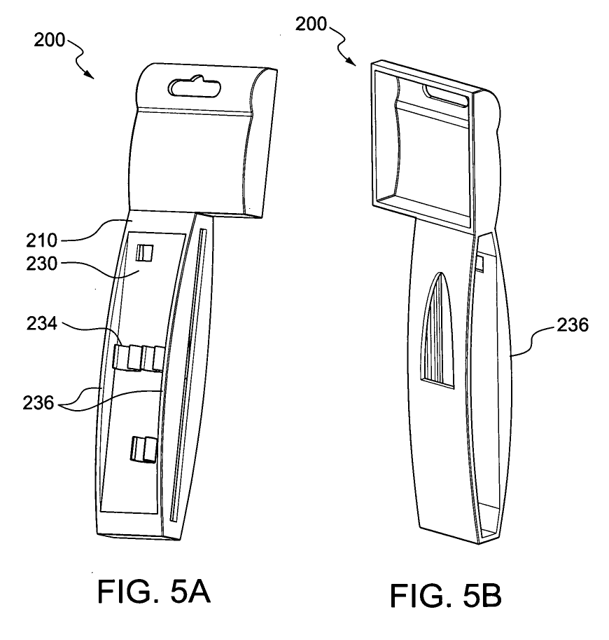

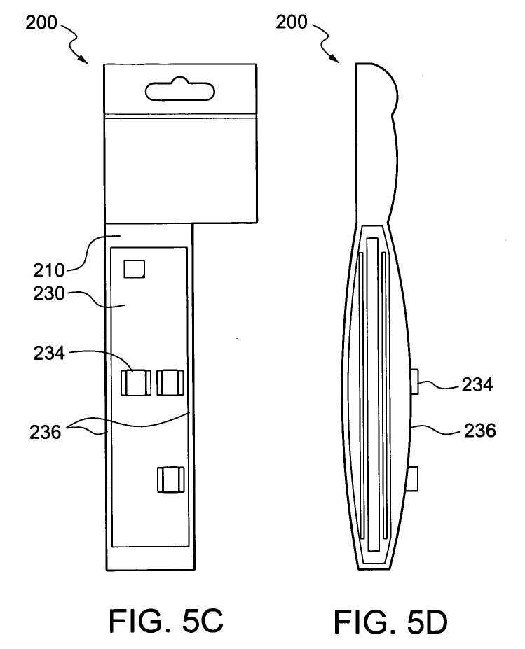

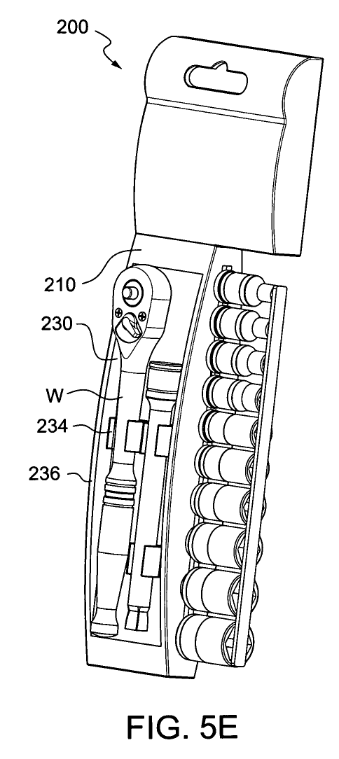

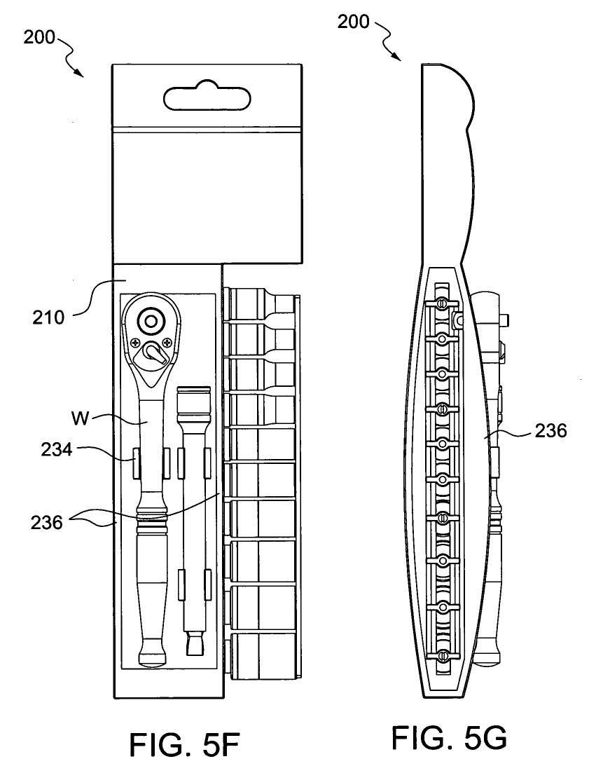

FIGS. 5A to 5G illustrate a tool storage rack 200 according to a third embodiment of the present invention. The tool storage rack 200 shares the structure of the tool storage rack 100 storing a single line of tools, and further accommodates a wrench. Particularly, the rack body 210 of the tool storage rack 200 includes a wrench accommodation surface 230 having at least one wrench clamp 234 to clamp a wrench W. Preferably, the wrench accommodation surface 230 has a recessed surface, and the wrench clamp 234 is located on the recessed surface, the edge of the recessed surface being preferably surrounded by external flanges 236. Such a structure not only allows the wrench W to be accommodated on the flat surface, but also protects the wrench W and provides a pleasant appearance through the external flanges 236. Besides, the wrench accommodation surface 230 may be detachably connected to the rack body 210.

### Embodiment 4

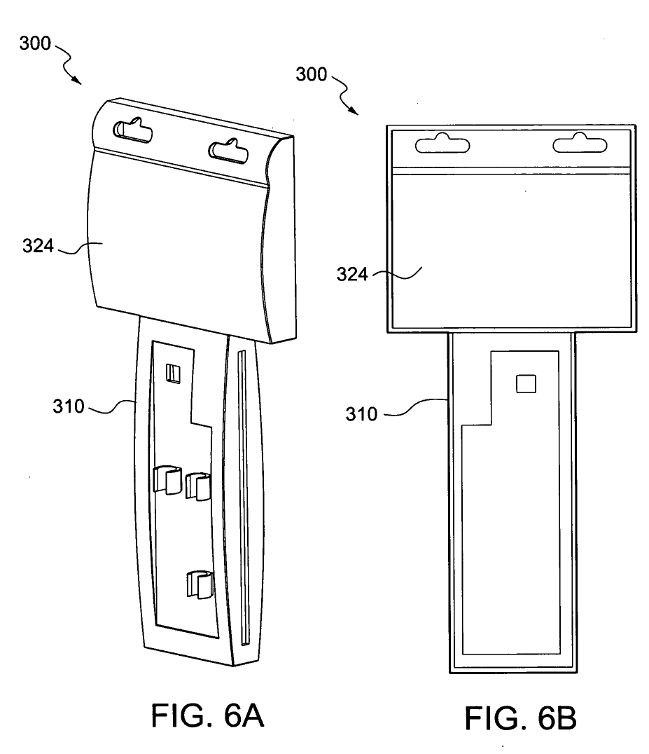

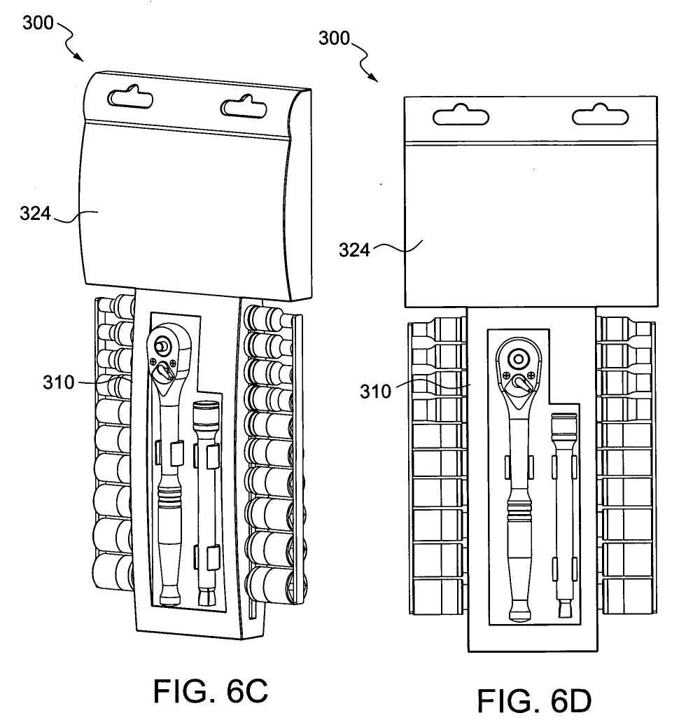

FIGS. 6A to 6D show a tool storage rack 300 according to a fourth embodiment of the present invention, which is similar in structure to the tool storage rack 200 of FIGS. 5A to 5C, the difference being that the tool storage rack 300 can store two lines of tools in addition to the wrench. As shown in the figures, the rack body 310 exhibits an overall T-shaped appearance because the width of a rack body 310 is smaller than that of a handle 320 and/or an information/advertisement window 324.

### Embodiment 5

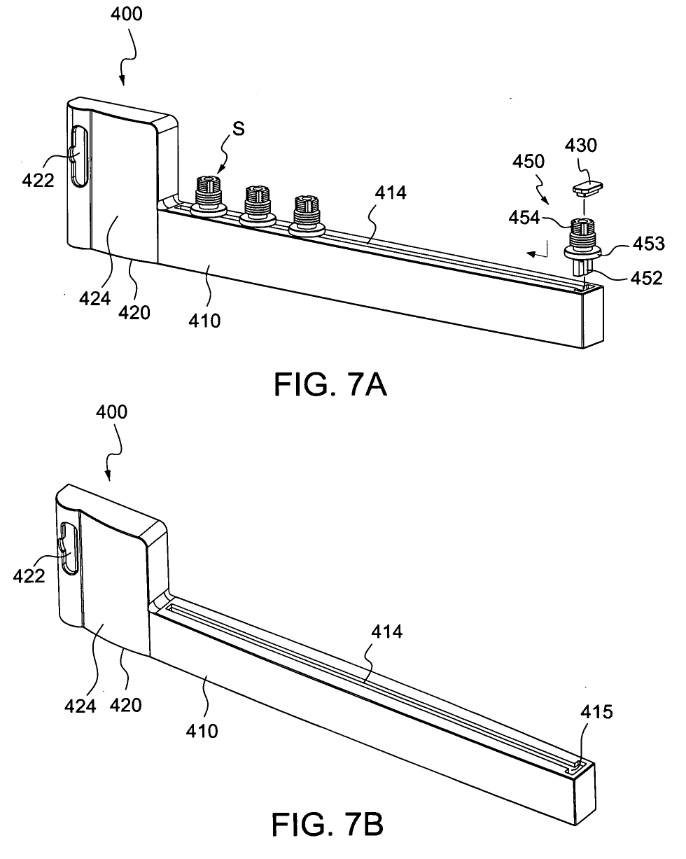

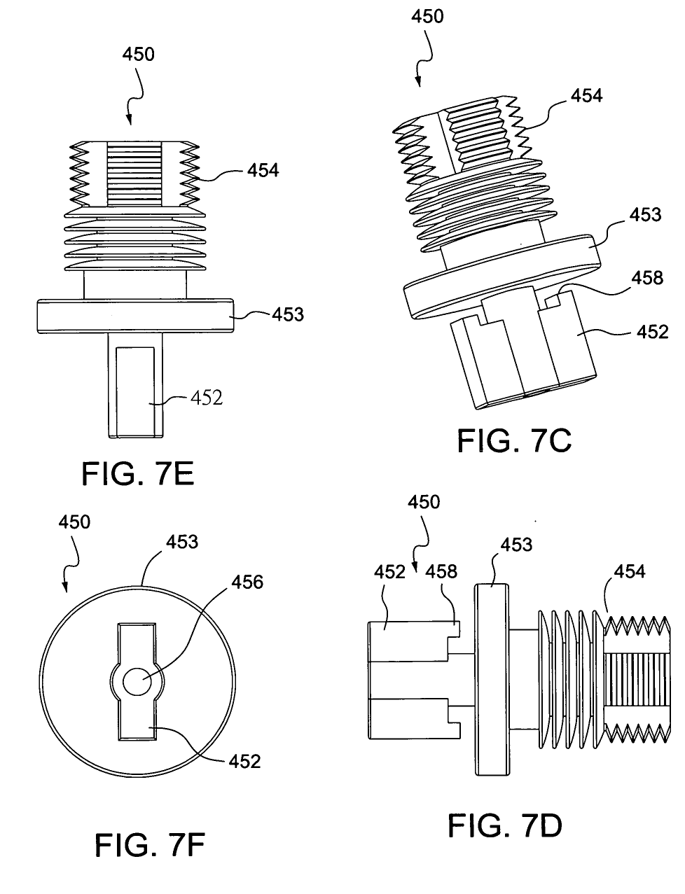

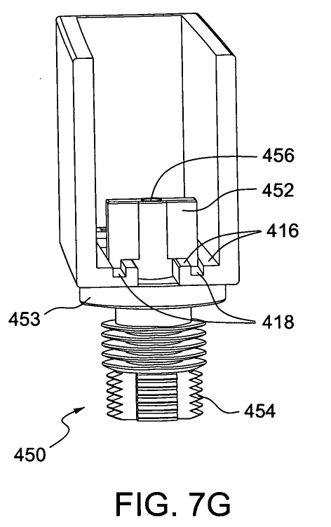

FIGS. 7A-7G show a tool storage rack 400 according to a fifth embodiment of the present invention which is a modification of the first embodiment. The tool storage rack 400 substantially comprises: a rack body 410 providing a hollow space and including at least one accommodation surface 412 formed with an installation groove 414, and at least one tool connector 450 configured for being partly inserted into the installation groove 414 along an installation direction to be engaged with the rack body 410, wherein the end of the installation groove 414 does not extend to the end(s) of the rack body 410/the accommodation surface 412, and the installation groove 414 is formed with at least one initiation portion 415 thereon, said initiation portion 415 allowing the tool connector 450 to be inserted into the installation groove 414 along the installation direction to engage the rack body 410.

The rack body 410, which is configured in substantially the same structure as the previous embodiments, includes a handle 420, a hanging part 422 and an information/advertisement window 424. The handle 420 has a concave/recessed structure to be held by a user, such as a concave/recessed groove beneath the hanging part 422 of FIGS. 7A-7B. Alternatively, the concave/recessed groove may be provided on a backside of the advertisement window 424.

The initiation portion 415 on the installation groove 414 is substantially an installation hole whose diameter is greater than the width of the installation groove 414, and the size thereof is large enough to accommodate a first engaging end 452 of the tool connector 450 (which will be described hereinafter). Although FIG. 7A discloses an elongated initiation portion 415/installation hole, it can be easily understood that, according to the spirit of the present invention, the initiation portion 415/installation hole is not limited to an elongated shape. Other shapes such as round or oval shape may also be used to carry out similar functions and achieve a pleasant appearance. The initiation portion 415/installation hole is closed with a locking element to prevent the tool connectors 450 installed in the installation groove 414 from sliding out. The locking element is preferably in the form of a sealing cover 430 corresponding to the initiation portion 415/installation hole, so as to close the initiation portion 415/installation hole. The above embodiments may be further modified on the basis of the spirit of the present invention. For example, the installation groove 414 may extend to the end(s) of the rack body 410 in a conventional manner with the end thereof closed by an end cap, similar to U.S. Pat. No. 5,228,570 in which the installation groove extends to a free end of the rack body and the free end is closed with an end cap 32). Preferably, the tool connector 450 comprises a limit block 453 serving as a barrier-like structure to work with the first engaging end 452 so that the tool connector 450, after being installed in the installation groove 414, can be confined by the accommodation surface 412 and the limit block 453. To work with the limit block 453, the first engaging end 452 may be shaped into a disk (not shown) or a block (not shown) which has a cross section that cannot pass through the installation groove 414. This can prevent the tool connector 450 from accidentally falling inside or out of the installation groove easily. The installation groove 414 may be formed as a single continuous slit or several discontinuous sections/slits. Furthermore, the rack body 410 and the installation groove 414 may also be configured in various shapes, such as a round shape or a triangular shape, instead of the slit/strip shape shown in the figures.

The tool connector 450 comprises: a first engaging end 452 configured for insertion into the initiation portion 415/installation hole of the installation groove 414; and a second engaging end 454 to connect to a tool to be accommodated (such as a socket). The first engaging end 452 has such a size that the first engaging end can be inserted into the initiation portion 415/installation hole, so that the tool connector 450 can be installed into the installation groove 414 of the rack body 410. The second engaging end 454 can be configured to accommodate different tools. For example, the tool connectors 450 shown in the figures are used to accommodate the sockets. For tool storage rack 400 used for holding sockets S, the outer surface of the second engaging end 454 can be provided with corrugations or wavy structure to work as a friction structure, so that a socket S can be held on the second engaging end 454 through the friction structure. According to another preferred embodiment, the second engaging end 454 includes a limit block 453 between the first engaging end 452 and the second engaging end 454 to work as a barrier, and the limit block 453 is preferably spaced apart from the first engaging end 452. The limit block 453 has a cross section larger than the width of the installation groove 414, so as to confine the tool connector 450 to be engaged between the accommodation surface 412 and the limit block 453. In one aspect, after the tool connector 450 is inserted into the initiation portion 415/installation hole of the installation groove 414, the limit block 453 can properly block (limit) the insertion motion or prevent the tool connector 450 from accidentally falling out of the installation groove 412. In another aspect, the limit block 453 can prevent the socket S from directly contacting the accommodation surface 412 to cause abrasions. The limit block 453 shown in the figures is round in shape, but it may have other shapes. A stabilization element (not shown) for contacting/engaging the end of the first engaging end 452 may be optionally disposed in the hollow space of the rack body 410, so as to stabilize the first engaging end 452 after installation.

When installing of the tool storage rack 400, firstly, as shown in FIG. 7A, the user holds the tool connector 450 to insert it into the initiation portion 415 of the installation groove 414 along an installation direction (for example, an orthogonal direction as shown in the figures) different from the longitudinal direction of the installation groove 414, until the insertion motion is blocked by, for example, the limit block 453, the second engaging end 454, or a stabilization element (not shown) located in the hollow space of the rack body 410. Thereafter, the user can then slide the tool connector 450 along the installation groove 414 for positioning, so as to complete the installation of the tool connector 450 on a backside 416 of the accommodation surface 412. In order to achieve such a positioning effect, the backside 416 (i.e., the side facing the hollow space) of the accommodation surface 412 may be provided with a stopping structure, friction structure, or other positioning structure (such as the stabilization element disposed in the hollow space of the rack body 410) to position the tool connector 450. In this embodiment, the backside 416 of the accommodation surface 412 preferably has a positioning structure 418 thereon. The positioning structure 418 is preferably formed in a trench-shaped positioning groove (see FIG. 7G), which, as described above, may be formed as a single continuous slit or several discontinuous sections/slits. Correspondingly, the first engaging end 452 of the tool connector 450 has a corresponding embedding part 458 to engage the positioning structure 418 (as shown in FIGS. 7C-7D, the embedding part 458 is a bump to engage the positioning groove to slide therein). In another embodiment, the positioning structure 418 may also be a positioning hole (not shown) disposed at a predetermined position, so that the embedding part 458 in the form of a bump can slide into the predetermined positioning hole for positioning. After a required number of tool connectors 450 are installed, the initiation portion 415/installation hole can be closed with a locking element/sealing cover 430.

The above “slidable” feature makes installation very convenient. Take a tool storage rack for storing sockets for example. When the sockets to be engaged with the tool connectors 450 have different diameters, such a slidable feature allows the sockets to slide to an appropriate installation position regardless of the difference in socket sizes.

It can be understood that, in the above embodiments, only the first engaging end 452 of the tool connector 450 is inserted into the installation groove 414 (which does not extend to the end(s) of the rack body 410/accommodation surface 412) for positioning, e.g., in the positioning structure 418, and then the tool connector 450 can slide in the installation groove 414 for further positioning. Compared with the prior art using exterior rails (generally T-shaped rails) coupling with slide blocks to allow the tool connector to slide on the rails, the tool connector of the present invention has greatly improved efficacy. Particularly, the installation groove 414 on the rack body 410 of the present invention can be designed as a closed, slit-shaped structure that does not extend to the end(s) of the rack body 410/accommodation surface 416, so that the rack body 410 does not need positioning blocks/end caps at the tail end (free end) thereof or solid external T-shaped rails which are usually need in the prior art. The present invention therefore provides advantages over the prior art due to simpler structure of the rack body 410, lower manufacturing cost (particularly because that the rack body 410 can be integrally formed), and greater strength.

This embodiment can also be used together with the anti-theft assembly 180 as shown in FIG. 1E, so as to prevent the socket S from accidentally failing off the tool connector 450 and avoid unauthorized removal of the same from the tool connector 450. The concept and structure of the anti-theft assembly 180 have been explained in detail in the foregoing paragraphs.

### Embodiments 6-7

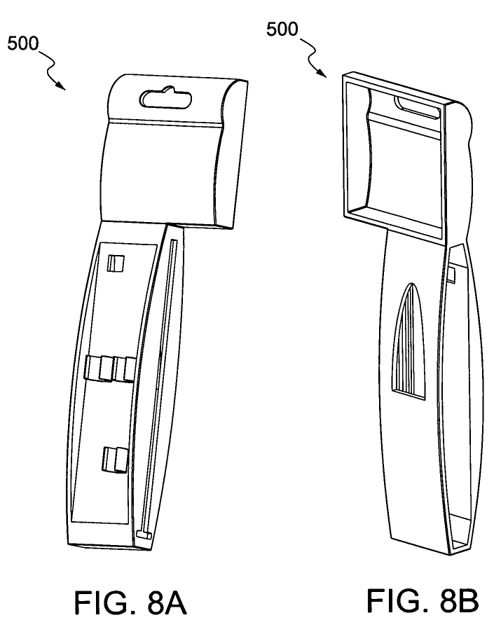

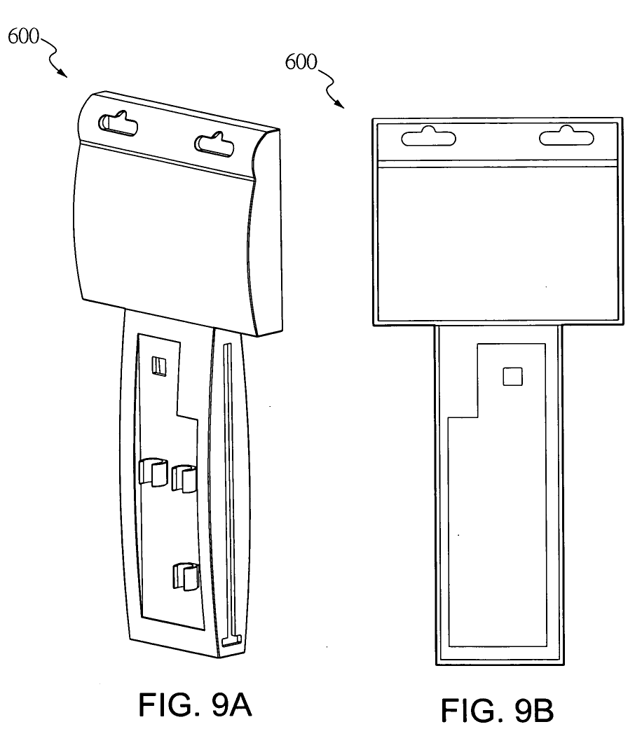

FIGS. 8A-8B, and 9A-9B are schematic views of a sixth embodiment and a seventh embodiment of the present invention, which are modifications of FIGS. 5E and 6C with an installation groove 414 shown in FIGS. 7A, 7B, and 7G. The concept and structure of these embodiments have substantially been explained in details in the above descriptions. The embodiments shown in these figures may also include the anti-theft assembly 180 in FIG. 1E.

All the above descriptions are intended to demonstrate the preferred embodiments of the present invention rather than limit the present invention. Since the present invention is not limited to the specific details described in connection with the preferred embodiments, changes to and implementations of certain features of the preferred embodiments without altering the overall basic function of the invention are contemplated within the scope of the appended claims.

We claim:

1. A tool storage rack, comprising:
a rack body, which provides a hollow space and comprises at least one accommodation surface formed with an installation groove; and
at least one tool connector configured for being partly inserted into the installation groove along an installation direction for engaging the rack body, wherein said at least one tool connector comprises:
a first engaging end configured for being inserted into the installation groove of the rack body along said installation direction and installed on the accommodation surface; and
a second engaging end for connecting to a tool to be accommodated.

2. The tool storage rack according to claim 1, wherein the second engaging end comprises a limit block between the first engaging end and the second engaging end, said limit block having a cross section larger than the width of the installation groove and spaced a gap from the first engaging end.

3. The tool storage rack according to claim 1, wherein the tool connector is formed with a through hole extending from the first engaging end to the second engaging end.

4. The tool storage rack according to claim 3, wherein the tool connector is configured for securing a socket, and wherein said tool storage rack further comprises an anti-theft assembly including a release-proof structure for further securing the socket, said anti-theft assembly further including at least one locking tab adaptable for passing through a hollow portion of the socket and extending to the first engaging end from the second engaging end of the tool connector along said through hole and being secured at the end of said first engaging end.

5. The tool storage rack according to claim 4, wherein an end structure of each locking tab has a substantially hollow portion and has an arrow-shaped configuration tapering from a thick stopper to a thin end, such that said end structure can be squeezed towards said hollow portion.

6. The tool storage rack according to claim 4, wherein the through hole has a structure substantially tapering from the second engaging end towards the first engaging end of the tool connector.

7. The tool storage rack according to claim 1, wherein the first engaging end of the tool connector is configured for engagement with or disengagement from with a backside of said accommodation surface after being rotated by a certain angle.

8. The tool storage rack according to claim 1, wherein said first engaging end is installed on a backside of the accommodation surface, said backside of the accommodation surface has a positioning structure, and said first engaging end has an embedding part corresponding to the positioning structure for engagement therewith.

9. The tool storage rack according to claim 8, wherein the positioning structure is formed into a trench-shaped positioning groove, and the embedding part is a bump for being engaged in the positioning groove to slide therein.

10. The tool storage rack according to claim 1, wherein the installation groove has a closed, slit-shaped structure that does not extend to the end(s) of the rack body.

11. The tool storage rack according to claim 1, wherein the installation direction is different from the longitudinal direction of the groove.

12. The tool storage rack according to claim 1, wherein the second engaging end has a cross section larger than a width of the installation groove.

13. The tool storage rack according to claim 1, wherein the rack body has a stabilization element in the hollow space for contacting the first engaging end.

14. The tool storage rack according to claim 7, wherein the first engaging end of the tool connector is configured for installation on or disengagement from the installation groove at a first angle and engagement with the installation groove at a second angle.

15. The tool storage rack according to claim 7, wherein the first engaging end of the tool connector has a width less than that of the installation groove.

16. A rack body, which is adaptable for engaging a tool connector to constitute a tool storage rack according to claim 1, said rack body providing a hollow space, and comprising at least one accommodation surface formed with an installation groove which allows a first engaging end of the tool connector to pass through and engaging therewith.

17. The rack body according to claim 16, wherein the installation groove has a closed, slit-shaped structure that does not extend to the end(s) of the rack body.

18. The rack body according to claim 16, wherein a backside of the accommodation surface has a positioning structure.

19. The rack body according to claim 18, wherein the positioning structure is formed into a trench-shaped positioning groove.

20. A tool connector, which is adaptable for being engaged with a rack body as claimed in claim 16 to constitute a tool storage rack for accommodating tools, said rack body having at least one accommodation surface formed with an installation groove, said tool connector comprising:
a first engaging end configured for passing through the installation groove of the rack body and being installed on the accommodation surface of the rack body; and
a second engaging end for connecting to a tool.

21. The tool connector according to claim 20, wherein the first engaging end is configured for engagement with or disengagement from a backside of the accommodation surface after being rotated by a certain angle.

22. The tool connector according to claim 20, wherein the second engaging end comprises a limit block between the first engaging end and the second engaging end, said limit block having a cross section larger than the width of the installation groove and spaced a gap from the first engaging end.

23. The tool connector according to claim 20, wherein the second engaging end has a cross section larger than a width of the installation groove.

24. The tool connector according to claim 23, wherein the first engaging end of the tool connector is configured for installation on or disengagement from the installation groove at a first angle and engagement with the installation groove at a second angle.

25. The tool connector according to claim 20, comprising a through hole extending from the first engaging end to the second engaging end.

26. The tool connector according to claim 25, wherein the through hole has a structure substantially tapering from the second engaging end towards the first engaging end of the tool connector.

27. The tool connector according to claim 25, wherein the through hole extends from a center of the first engaging end to a center of the second engaging end.

28. The tool connector according to claim 27, wherein the through hole has a structure substantially tapering from the second engaging end towards the first engaging end of the tool connector.

29. A method for assembling a tool storage rack, comprising:
(a) providing a rack body having a hollow space and at least one accommodation surface, said accommodation surface having a closed installation groove that does not extend to the end(s) of the rack body;
(b) providing at lease one tool connector, wherein said at least one tool connector has a first engaging end and a second engaging end for connecting to a tool to be accommodated;
(c) inserting the first engaging end of the tool connector into the installation groove along an installation direction, until the inserting motion is stopped by a structure on the tool connector; and
(d) rotating the tool connector for a certain angle, until the first engaging end is engaged on a backside of the accommodation surface and positioned thereon.

30. The method for assembling a tool storage rack according to claim 29, wherein in Step (c), the first engaging end of the tool connector is inserted into the installation groove along an installation direction different from an longitudinal direction of the installation groove.

31. A tool storage rack, comprising:
a rack body providing a hollow space and comprising at least one accommodation surface, wherein the accommodation surface has an installation groove, the installation groove having at least one installation initiation portion; and
at least one tool connector configured for being inserted into the installation groove along an installation direction through the initiation portion of the installation groove for engagement with the rack body, said at least one tool connector comprising:
a first engaging end configured for being inserted into the installation groove of the rack body along the installation direction for installation on the accommodation surface; and
a second engaging end for connecting a tool to be accommodated.

32. The tool storage rack according to claim 31, wherein the second engaging end comprises a limit block between the first engaging end and the second engaging end, said limit block having a cross section larger than that of the installation groove and forms a gap from the first engaging end.

33. The tool storage rack according to claim 31, wherein the first engaging end of the tool connector is configured for engagement with or disengagement from with a backside of said accommodation surface after being rotated by a certain angle.

34. The tool storage rack according to claim 31, wherein the first engaging end is installed on a backside of the accommodation surface, said backside has a positioning structure, and said first engaging end has an embedding part corresponding to and for being engaged with the positioning structure.

35. The tool storage rack according to claim 34, wherein the positioning structure has a trench-shaped positioning groove, and the embedding part is a bump engaged in the positioning groove for sliding therein.

36. The tool storage rack according to claim 31, wherein the installation groove of the accommodation surface does not extend to the end(s) of the rack body.

37. The tool storage rack according to claim 31, wherein the installation groove has a closed, slit-shaped structure that does not extend to the end(s) of the rack body.

38. The tool storage rack according to claim 31, wherein the installation direction is different from the longitudinal direction of the groove.

39. The tool storage rack according to claim 31, wherein second engaging end has a cross section larger than a width of the installation groove.

40. The tool storage rack according to claim 31, wherein the rack body includes a stabilization element in the hollow space for contacting the first engaging end.

41. The tool storage rack according to claim 33, wherein the first engaging end of the tool connector is configured into an approximate strip shape having a width less than that of the installation groove.

42. The tool storage rack according to claim 31, wherein the at least one initiation portion is an installation hole having a width larger than that of the installation groove so as to accommodate the first engaging end of the tool connector.

43. The tool storage rack according to claim 31, wherein the initiation portion is closed with a sealing cover.

44. A rack body, which is adaptable for engaging a tool connector to constitute a tool storage rack as claimed in claim 31, said rack body having a hollow space and comprising at least one accommodation surface formed with an installation groove which allows a first engaging end of the tool connector to pass through and engaging therewith, wherein the installation groove has at least one initiation portion and closed with a sealing cover.

45. The rack body according to claim 44, wherein the installation groove has a closed, slit-shaped structure that does not extend to the end(s) of the rack body.

46. The rack body according to claim 44, wherein a backside of the accommodation surface has a positioning structure.

47. The rack body according to claim 46, wherein the positioning structure is formed into a trench-shaped positioning groove.
